(19) United States
(12) Patent Application Publication
(10) Pub. No.: US 2019/0316215 A1
(43) Pub. Date: Oct. 17, 2019

(54) Portable Self-Contained Reverse Osmosis System

(71) Applicant: Carl R. Nylen, Fulton, NY (US)

(72) Inventor: Carl R. Nylen, Fulton, NY (US)

(21) Appl. No.: 15/953,527

(22) Filed: Apr. 16, 2018

(51) Int. Cl. C13B 20/16; B01D 61/02; B01D 61/08; B01D 61/04

(52) U.S. Cl. CPC C13B 20/165; B01D 61/025; B01D 61/08; B01D 61/04; B01D 61/022; B01D 2311/04; B01D 2317/04; B01D 2311/2619; B01D 2313/19; B01D 2313/243; B01D 2313/365; B01D 2317/022; B01D 2311/2649

(57) ABSTRACT

The invention provides for a portable, self-contained reverse osmosis system of which all necessary components to carry out substrate processing fit within the containment vessel. The invention weighs fewer than 50 pounds, consumes fewer than 250 watts of electricity, and can easily be carried from one location to another. While the invention is capable of processing hundreds of gallons of substrate per day, it can efficiently process as little as one gallon of substrate at a given time.

### CROSS-REFERENCE TO RELATED APPLICATIONS

Provisional EFS ID: 28998573

### STATEMENT REGARDING FEDERALLY SPONSORED RESEARCH OR DEVELOPMENT (IF APPLICABLE)

N/A

### BACKGROUND OF THE INVENTION

The invention involves the scaling down of existing reverse osmosis methods to fit in a portable, self-contained unit capable of processing significant amounts of water from a given substrate. While such a portable unit has many potential utilities, current emphasis is placed on the processing of tree sap into tree syrup.

The processing of tree sap into tree syrup involves increasing the sugar concentration of the sap to approximately 66%. This is traditionally done by removing significant amounts of water from the sap in a time and energy-consuming boiling process. Reverse osmosis is one method currently used to pre-concentrate sugars in tree sap.

Reverse osmosis systems currently available are for use in large-scale operations and are prohibitively expensive for hobbyist tree syrup producers who typically process fewer than 100 gallons of sap at a time. Such reverse osmosis systems, which include a means of drawing in and pressurizing significant amounts of substrate, lack portability and are not economical for processing smaller amounts of sap (between one and 100 gallons). Even the smallest of these reverse osmosis systems currently available is designed to process over 100 gallons of substrate at a time, weighs over 50 pounds, and uses more than 250 watts of electricity. Due to their cost, size, maintenance, and set-up time, current large-scale systems are impractical for most tree syrup hobbyists.

While portable, light-weight (fewer than 50 pounds) reverse osmosis systems currently exist, these systems do not contain a means of drawing in significant amounts of substrate to be processed. They also lack the ability to increase the pressure of the incoming substrate, a function of which increases the efficiency of the reverse osmosis process. Existing portable, lightweight reverse osmosis systems either rely on already pressurized sources of feedstock for separation, separate pumps to achieve efficient separation (they lack self-containment), or non-powered means that extremely limit processing amounts.

There exists a need for a lightweight, portable, self-contained reverse osmosis system for hobbyist tree syrup producers. The unit should weigh fewer than 50 pounds and have the ability to be easily carried between locations of use and to a heated area to prevent freezing (where applicable) when not in use. Furthermore, the invention should contain an internal mains of pumping/pressurizing significant amounts of substrate to aid in the ease of use and portability. The invention should use fewer than 250 watts of electricity to aid in off-grid applications, while requiring an experienced user no more than 15 minutes to set up, flush, and put away.

### BRIEF SUMMARY OF THE INVENTION

The present invention provides for a portable, self-contained system that weighs fewer than 50 pounds, can economically process fewer than 100 gallons of substrate (such as sap) at a time, and consumes fewer than 250 watts of electricity. Such a system may achieve up to 10 brix concentration of sugar in tree sap and may be set up and taken down in fewer than 15 minutes by an experienced user.

The basis for portability of the present invention is that all components are fitted within a bucket that has a total volume equal to or fewer than seven gallons. Such a bucket can be easily moved from one location to another. The system may therefore be used to process a wide variety of substrates. The quick start-up and shut-down times allow users to efficiently process quantities of substrate as small as one gallon. When processing sap, the portability allows the system to be used in the woods where sap is collected or near an evaporator pan. The portability and ease of setup allow for easier sap collection as water can be removed before sap is moved to the site of traditional evaporation. The bucket can easily be moved to an area above freezing (where applicable) when not in use.

The portable reverse osmosis system is comprised of a pressure booster pump capable of up to 150 psi, a means of powering the booster pump, a sediment filter housing fewer than 20″ in length, one or more reverse osmosis membranes of individual capacity less than 600 gpd, and a restriction or metering device. Other standard reverse osmosis parts are used to complete the functionality of the unit, including hoses and fittings. Additional parts may include an ultraviolet purification assembly and solar panel capable of charging an internal electric storage device and/or directly powering the system.

### BRIEF DESCRIPTION OF THE SEVERAL VIEWS OF THE DRAWING

FIG. 1—Component diagram of portable, self-contained reverse osmosis system.

FIG. 2—Example of a series plumbing schematic for a multiple membrane system.

FIG. 3—Example of a parallel plumbing schematic for a multiple membrane system.

### DETAILED DESCRIPTION OF THE INVENTION

The portable self-contained reverse osmosis system consists of the following items:

1. Bucket with a volume equal to or fewer than 7 gallons

2. Internal separator plate designed to organize internal components

3. Pressure booster pump capable of up to 150 psi

4. Means of powering pressure booster pump (power transformer or internal power source)

5. Sediment filter housing assembly fewer than 20″ long (containing sediment filter)

6. Reverse osmosis membrane housing assembly (containing reverse osmosis membrane)

7. Restriction/metering device

8. Intake (substrate) suction hose

9. Outlet permeate (water) hose

10. Outlet concentrate hose

11. Lid or means of closing system

12. Ultraviolet purification assembly

13. Solar panel

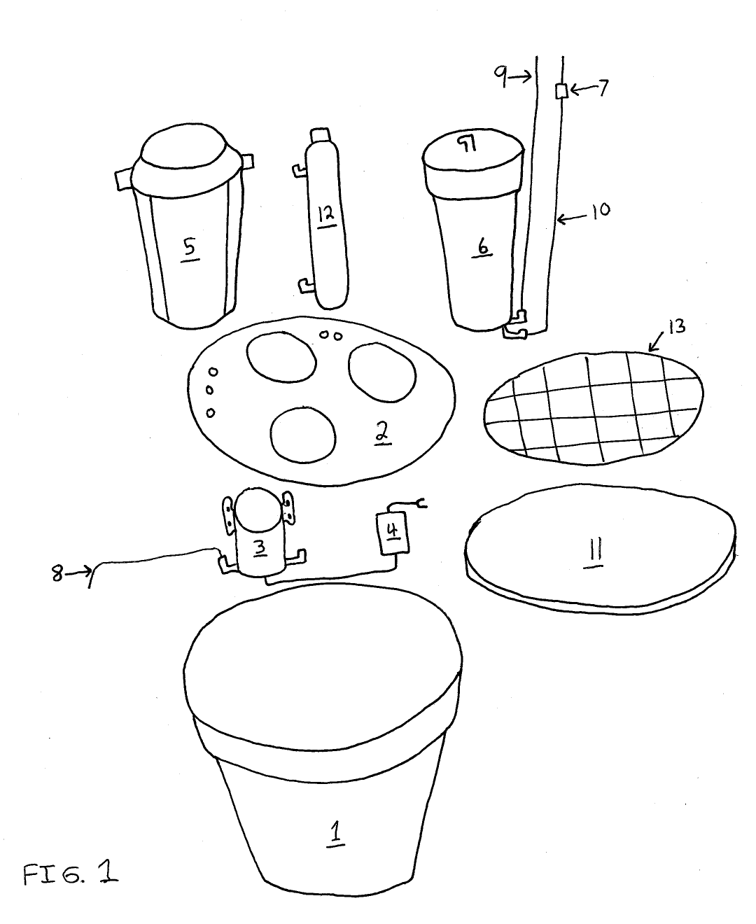

FIG. 1 depicts a component diagram of the portable, self-contained reverse osmosis system. Items 2-13 are self-contained within the bucket (item 1) with a volume equal to or fewer than 7 gallons. The lid (Item 11) fits on top of the bucket and allows the system to be sealed and stored when not in use. The separator plate (item 2), which contains specific cut-outs to fit various housings and an ultraviolet purification assembly (12), acts as a means of organizing the contents within the bucket. The separator plate (item 2) has a diameter that is designed to rest against the tapered inside edge of the bucket (item 1), or is incorporated into the bucket itself. The pressure booster pump (item 3) is attached, using appropriate fasteners, to the inside bottom or internal side of the bucket (item 1). A means of powering (item 4) the pressure booster pump can come from a power transformer (relying on an external power source) stored inside the bucket or a rechargeable internal power source that is affixed to the inside of the bucket. Alternatively, power could be supplied directly from a solar panel (item 11) incorporated into the lid of the system. The sediment filter housing assembly (item 5) is placed into the appropriate cut-out of the separator plate (item 2). The membrane housing assembly (item 6) is placed in the appropriate cut-out of the separator plate (item 2). An ultraviolet purification assembly (item 12) may also be placed in an appropriate cut-out in the separator plate. The pressure booster pump (item 3) inlet is equipped with a length of hose to be used as an intake (substrate) suction hose (item 8) for substrate to be processed. This often contains a fine mesh strainer for the purpose of pre-filtering large sediment from the substrate. This intake (substrate) suction hose (item 8) can pass through the separator plate or a “thru hull” fitting to the exterior of the bucket. The pressure booster pump (item 3) outlet is connected to the sediment filter (item 5) inlet with appropriately-sized tubing. This tubing can either run through a hole in the separator plate or a “thru hull” style fitting to the exterior of the bucket.

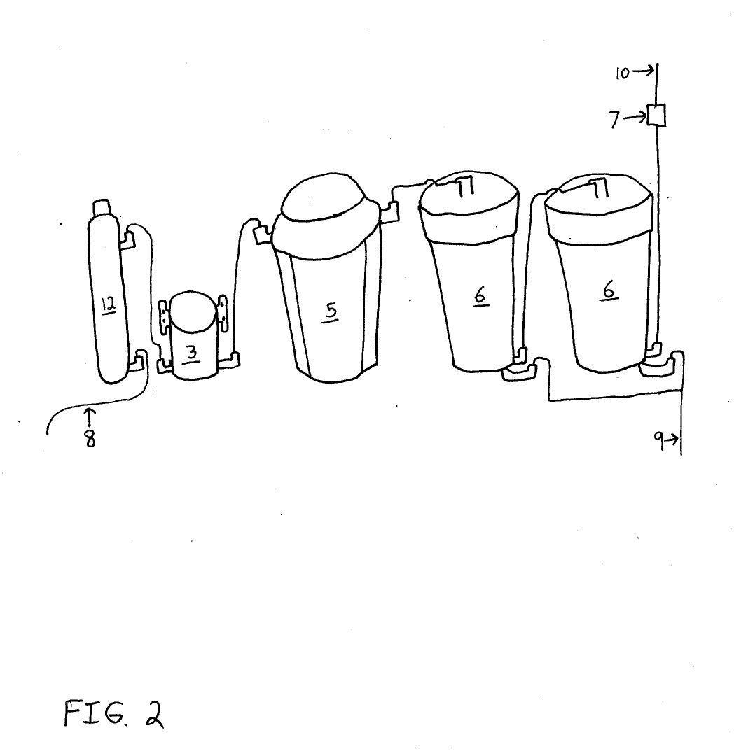

FIG. 2 depicts an example of a series plumbing configuration. The intake (substrate) suction hose (item 8) is connected to the ultraviolet purification assembly (item 12). The ultraviolet purification assembly is then connected to the pressure booster pump (item 3) inlet. The pressure booster pump (item 3) outlet is connected to the sediment filter housing assembly (item 5) inlet. The sediment filter housing assembly (item 5) outlet is connected to the first reverse osmosis membrane housing assembly (item 6) inlet. The concentrate outlet of the first reverse osmosis membrane housing assembly will be plumbed to the inlet of a second reverse osmosis membrane housing assembly. The tubing will attach to the concentrate outlet of the first reverse osmosis membrane housing assembly through the separator plate (item 2) and into the inlet of the second reverse osmosis membrane housing assembly (item 6). A metering device will be placed on the outlet concentrate hose (item 10) of the last reverse osmosis membrane housing assembly. The metering/restriction valve (item 7) can be a calibrated flow restrictor or an adjustable needle valve. The permeate outlets of the reverse osmosis membrane housings assemblies will be plumbed together and terminate at the outlet permeate (water) hose (item 9). The outlet concentrate hose (item 10) and outlet permeate (water) hose (item 9) can pass thru the separator plate, or through a “thru hull” connector to the exterior of the bucket.

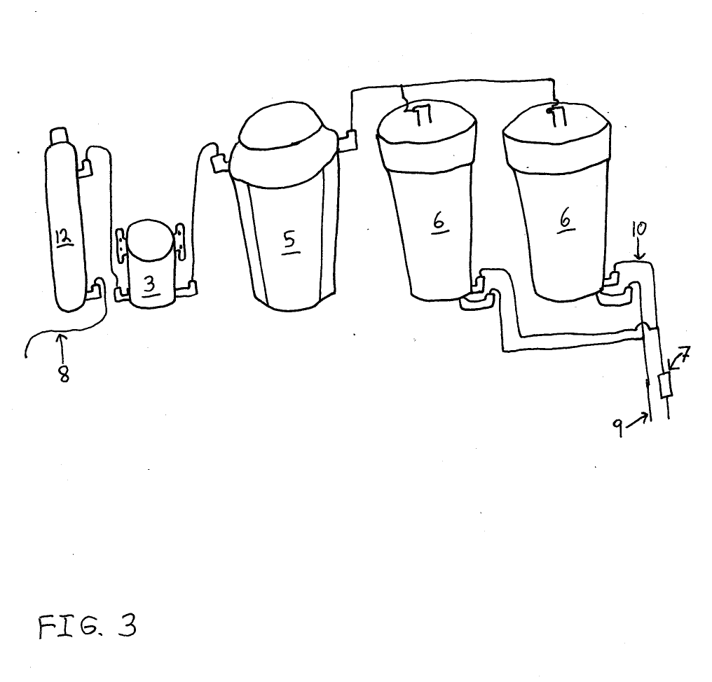

FIG. 3 depicts an example of a parallel plumbing configuration. The intake (substrate) suction hose (item 8) is connected to the ultraviolet purification assembly (item 12). The ultraviolet purification assembly is then connected to the pressure booster pump (item 3) inlet. The pressure booster pump (item 3) outlet is connected to the sediment filter housing assembly (item 5) inlet. The sediment filter housing assembly (item 5) outlet is connected to the plurality of reverse osmosis membrane housing assembly (item 6) inlets. The concentrate outlets of the plurality of reverse osmosis membrane housing assemblies will be plumbed together. A metering device will be placed after the connected concentrate outlets, terminating at the outlet concentrate hose (item 10). The metering/restriction valve (item 7) can be a calibrated flow restrictor or an adjustable needle valve. The permeate outlets of the plurality of reverse osmosis membrane housing assemblies will be plumbed together and terminate at the outlet permeate (water) hose (item 9). The outlet concentrate hose (item 10) and outlet permeate (water) hose (item 9) can pass thru the separator plate, or through a “thru hull” connector to the exterior of the bucket.

The steps for using the system are as follows:

1. The lid is removed from the bucket. The components necessary to begin substrate processing are located. This includes the power source, intake (substrate) suction hose, outlet permeate (water) hose, and outlet concentrate hose. The hoses are pre-plumbed through the separator plate or the user attaches them to their corresponding “thru hull” fitting in the side of the bucket. Unlike existing large-scale reverse osmosis systems, this invention consumes very little electricity (fewer than 250) watts. It can be plugged into a standard 110 v outlet, 220 v outlet, or utilize an alternative power source (like a battery or inverter). The pressure booster pump, which may vary from 12-48 volt inputs, can run off multiple power sources. Power may come from an external 110 v or 220 v source through a transformer. Alternatively, the system may be powered by an external or internal 12-48 v power source.

2. The intake suction hose is placed in the substrate to be processed and substrate flows into the system. This is different from existing light-weight reverse osmosis systems in that the present invention can draw substrate from any type of container through a single flexible intake tube. It does not need to be plumbed to a separate pressurization device, or attached in any way to a storage vessel. Unlike existing reverse osmosis systems, the ability for this system to draw in and pressurize substrate from a flexible tube allows users to process quantities of substrate as small as one gallon, from any container or location where substrate has pooled.

3. Once substrate starts flowing out of the outlet concentrate hose, the user creates restriction by decreasing the flow of substrate through the needle valve. Alternatively, a pre-calibrated restrictor is used in place of the needle valve to create restriction and increase the pressure within the system. Once the permeate and concentrate outlet hoses are flowing at an acceptable rate (between 10% to 70% water removal as determined by the user), permeate begins flowing through the permeate discharge outlet. This single flow control device aides in the ease of use of the system and decreases the amount of time necessary to start processing substrate.

4. Upon completion of substrate processing, the unit is flushed with permeate water. One method of permeate flushing involves removal of the intake suction hose from the substrate allowing the unit to run dry. The user then places the intake suction hose into saved permeate water, and the system is flushed with permeate water using to no restriction. The amount of permeate water used for flushing is equal to the permeate produced, or up to 10 gallons. The hoses, transformer, and other parts can then be placed back into the container. The container is sealed with the lid, and stored until next use. If the system is not to be used for over a week, common reverse osmosis cleaning agents can be pumped through the system to minimize biological growth and prolong membrane life. The volume displaced by this system (less than 1 gallon) aids in the time, ease and cost of flushing compared to large-scale reverse osmosis systems.

1. A portable reverse osmosis system that is self-contained in a five gallon bucket, or similarly-sized container, weighing fewer than 25 pounds, utilizing fewer than 250 watts of electricity, comprising: a means of drawing in and pressurizing substrate, a means of power, a sediment filter housing assembly for filtering substrate, one or more reverse osmosis membrane housing assemblies plumbed for the removal of water from substrate, and a restriction or metering device that limits substrate flow through the reverse osmosis membrane(s) concentrate outputs.

2. The portable reverse osmosis system of claim 1, of which further treatment of concentrate or permeate is permitted by the use of a self-contained ultraviolet purification device.

3. The portable reverse osmosis system of claim 1, of which power can be derived from a self-contained electric storage device that weighs no more than 15 additional pounds.

4. The portable reverse osmosis system of claim 3, of which a solar cell or array of solar cells is incorporated as a means of recharging the self-contained electric storage device.

5. A portable reverse osmosis system that is self-contained in a six gallon bucket, or similarly-sized container, weighing fewer than 25 pounds, utilizing fewer than 250 watts of electricity, comprising: a means of drawing in and pressurizing substrate, a means of power, a sediment filter housing assembly for filtering substrate, one or more reverse osmosis membrane housing assemblies plumbed for the removal of water from substrate, and a restriction or metering device that limits substrate flow through the reverse osmosis membrane(s) concentrate outputs.

6. The portable reverse osmosis system of claim 5, of which further treatment of concentrate or permeate is permitted by the use of a self-contained ultraviolet purification device.

7. The portable reverse osmosis system of claim 5, of which power can be derived from a self-contained electric storage device that weighs no more than 15 additional pounds.

8. The portable reverse osmosis system of claim 7, of which a solar cell or array of solar cells is incorporated as a means of recharging the self-contained electric storage device.

9. A portable reverse osmosis system that is self-contained in a seven gallon bucket, or similarly-sized container, weighing fewer than 35 pounds, utilizing fewer than 250 watts of electricity, comprising: a means of drawing in and pressurizing substrate, a means of power, a sediment filter housing assembly for filtering substrate, one or more reverse osmosis membrane housing assemblies plumbed for the removal of water from substrate, and a restriction or metering device that limits substrate flow through the reverse osmosis membrane(s) concentrate outputs.

10. The portable reverse osmosis system of claim 9, of which further treatment of concentrate or permeate is permitted by the use of a self-contained ultraviolet purification device.

11. The portable reverse osmosis system of claim 9, of which power can be derived from a self-contained electric storage device that weighs no more than 15 additional pounds.

12. The portable reverse osmosis system of claim 11, of which a solar cell or array of solar cells is incorporated as a means of recharging the self-contained electric storage device.
